(19) United States
(12) Patent Application Publication
(10) Pub. No.: US 2024/0413718 A1
(43) Pub. Date: Dec. 12, 2024

(54) MANUFACTURING APPARATUS FOR ROTOR AND METHOD OF MANUFACTURING ROTOR

(71) Applicant: TOYOTA BOSHOKU KABUSHIKI KAISHA, Aichi-ken (JP)

(72) Inventor: Masaaki TAKEMOTO, Toyokawa-shi (JP)

(73) Assignee: TOYOTA BOSHOKU KABUSHIKI KAISHA, Aichi-ken (JP)

(21) Appl. No.: 18/731,818

(22) Filed: Jun. 3, 2024

(30) Foreign Application Priority Data
Jun. 9, 2023 (JP) 2023-095617

(51) Int. Cl. H02K 15/02

(52) U.S. Cl. CPC H02K 15/02

(57) ABSTRACT

A manufacturing apparatus for a rotor includes a first member that is configured to contact one end face of the rotor core and close first openings of magnet housing holes, and a second member that is configured to close second openings of the magnet housing holes. The second member includes a supply portion configured to supply plastic to the second openings. A direction in which an axis of the rotor core extends is defined as an axial direction. An escape portion is provided in a portion of the first member that is configured to face, in the axial direction, a welding location at which the iron core pieces of the rotor core are to be welded to each other. The escape portion is located inward of an outer circumferential surface of the rotor core.

### CROSS-REFERENCE TO RELATED APPLICATIONS

This application is based upon and claims the benefit of priority from prior Japanese Patent Application No. 2023-095617, filed on Jun. 9, 2023, the entire contents of which are incorporated herein by reference.

### BACKGROUND

### 1. Field

The present disclosure relates to a manufacturing apparatus for a rotor and a method of manufacturing a rotor.

### 2. Description of Related Art

Japanese Laid-Open Patent Publication No. 2021-48674 discloses a method of manufacturing a rotor of a magnet-embedded motor. The manufacturing method includes a plastic filling step and a welding step. In the plastic filling step, magnets are inserted into magnet holes of a rotor core, and then the magnet holes are sealed with plastic. The rotor core is formed by stacking multiple metal plates. In the welding step, the metal plates are bound together by welding.

In the plastic filling step, for example, the manufacturing apparatus disclosed in Japanese Laid-Open Patent Publication No. 2019-140842 is used.

This manufacturing apparatus includes a stationary die, a cull plate, and a movable die, which is configured to contact and separate from the stationary die.

The stationary die includes a die body, a support member, and a spacer. The support member includes a base portion, which is fixed to the upper surface of the die body, and a cylindrical post portion, which protrudes from a center of the base portion and is inserted into a center hole of the rotor core. The spacer is arranged on the upper surface of the support member and contacts the lower surface of the rotor core.

The cull plate is placed on the upper surface of the rotor core. The cull plate includes multiple filling pots to fill the magnet housing holes of the rotor core with plastic.

The movable die includes a die body and a plate portion. The plate portion is fixed to the lower surface of the die body and contacts the upper surface of the cull plate. The plate portion includes first plastic supply passages connected to the filling pots. The die body includes second plastic supply passages, which are connected to the first plastic supply passages.

In this manufacturing apparatus, plastic is supplied to the second plastic supply passages of the die body, so that the magnet housing holes of the rotor core are filled with the plastic via the first plastic supply passages and the filling pots.

In the manufacturing apparatuses of the related art, including the manufacturing apparatus disclosed in Japanese Laid-Open Patent Publication No. 2019-140842, it is desirable from the standpoint of reducing the number of parts to standardize the jig that includes the support member and the spacer for both the plastic filling step and the subsequent welding step. However, in this case, problems may arise such as the rotor core and spacer being welded together or the welding machine interfering with the support member and the spacer. Therefore, in the related art, after the plastic filling step, it is necessary to remove the jig from the rotor core and attach a welding jig different from the removed jig to the rotor core.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a manufacturing apparatus for a rotor is provided. The rotor includes a cylindrical rotor core that is formed by stacking multiple iron core pieces and includes magnet housing holes for accommodating magnets, and a plastic that fills the magnet housing holes. The iron core pieces are welded to each other so as to be coupled together. The manufacturing apparatus includes a first member and a second member. The first member is configured to contact one end face of the rotor core and close first openings of the magnet housing holes that open in the one end face. The second member is configured to close second openings of the magnet housing holes on a side opposite to the first openings. The second member includes a supply portion configured to supply the plastic to the second openings. A direction in which an axis of the rotor core extends is defined as an axial direction. An escape portion is provided in a portion of the first member that is configured to face, in the axial direction, a welding location at which the iron core pieces are to be welded to each other. The escape portion is located inward of an outer circumferential surface of the rotor core.

In another general aspect, a method of manufacturing a rotor using the above-described manufacturing apparatus for a rotor is provided. The method includes: transporting the first member, the rotor core, and the second member to a space between a first die and a second die, the second die being provided to approach and separate from the first die; filling the magnet housing holes with the plastic by supplying the plastic from the second die to the second openings through the supplying portion; transporting the first member and the rotor core from the space between the first die and the second die to a welding line that welds the iron core pieces to each other; and performing welding on the welding location of the rotor core in the welding line in a state in which the rotor core is in contact with the first member.

Other features and aspects will be apparent from the following detailed description, the drawings, and the claims.

### BRIEF DESCRIPTION OF THE DRAWINGS

FIG. 1 is a perspective view of a rotor that is manufactured using a manufacturing apparatus for a rotor according to an embodiment.

FIG. 2 is a cross-sectional view of the rotor shown in FIG. 1.

FIG. 3 is a cross-sectional view of the manufacturing apparatus for a rotor and a rotor core according to the embodiment.

FIG. 4 is a plan view of a first member and a rotor core of the embodiment.

FIG. 5 is a cross-sectional view of the manufacturing apparatus and the rotor core shown in FIG. 3, mainly illustrating escape portions.

FIG. 6 is a plan view of the manufacturing apparatus and the rotor core shown in FIG. 5.

FIG. 7 is a cross-sectional view corresponding to FIG. 3, showing a plastic filling step.

FIG. 8 is a cross-sectional view showing the plastic filling step, illustrating a state in which magnet housing holes are filled with plastic.

FIG. 9 is a cross-sectional view corresponding to FIG. 5, illustrating a welding step.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

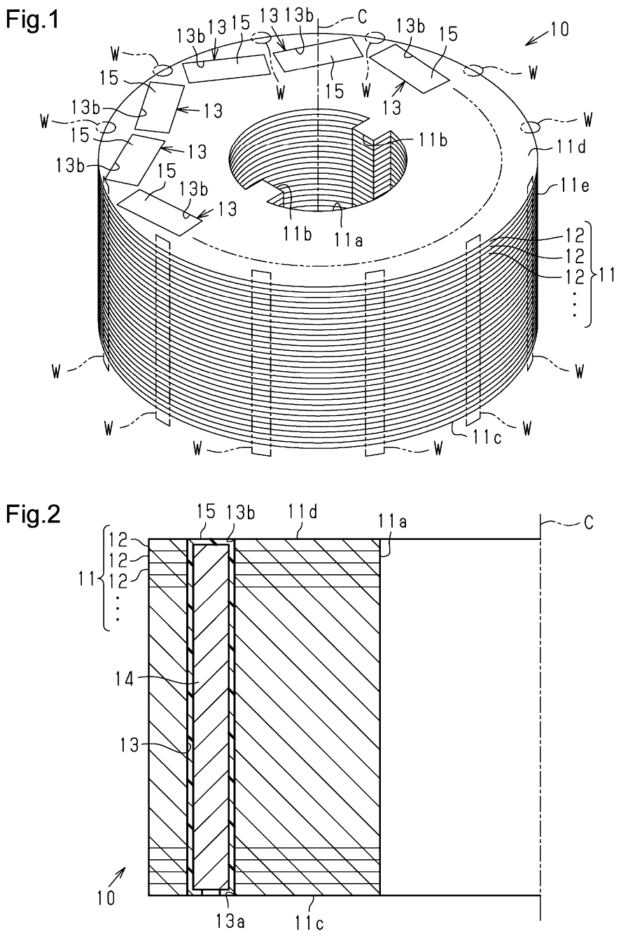

A manufacturing apparatus for a rotor and a method of manufacturing a rotor according to an embodiment will now be described with reference to FIGS. 1 to 9.

### Rotor 10

First, a rotor 10 of a magnet-embedded motor manufactured using a manufacturing apparatus 70 according to the present embodiment will be described with reference to FIGS. 1 and 2.

As shown in FIGS. 1 and 2, the rotor 10 includes a rotor core 11, magnets 14, and plastic 15.

The rotor core 11 has a cylindrical shape having an axis C.

In the following description, the axial direction of the rotor core 11 will simply be referred to as an axial direction, radial directions of the rotor core 11 will simply be referred to as radial directions, and a circumferential direction of the rotor core 11 will simply be referred to as a circumferential direction.

The rotor core 11 is formed by stacking, in the axial direction, iron core pieces 12 that are punched out from a magnetic steel sheet.

The rotor core 11 includes a center hole 11a and magnet housing holes 13.

The center hole 11a has a circular shape and extends through the rotor core 11 in the axial direction. Two key portions 11b project from the inner circumferential surface of the center hole 11a on opposite sides of the axis C.

The magnet housing holes 13 are located on the outer side in the radial direction of the center hole 11a and spaced apart from each other in the circumferential direction. Each of the magnet housing holes 13 is rectangular in plan view and extends in the axial direction through the rotor core 11. Thus, each magnet housing hole 13 includes a first opening 13a, which opens in an end face 11c on one side in the axial direction of the rotor core 11 (the lower side in the vertical direction in FIG. 1), and a second opening 13b, which is on the side opposite to the first opening 13a.

As shown in FIG. 2, each magnet housing hole 13 accommodates a magnet 14. Each magnet 14 has a rectangular parallelepiped shape extending in the axial direction. The magnets 14 are, for example, permanent magnets.

As shown in FIG. 2, each magnet housing hole 13 is filled with the plastic 15 for fixing the magnet 14 to the rotor core 11. The plastic 15 is, for example, a thermosetting plastic such as an epoxy plastic.

As shown in FIG. 1, the iron core pieces 12 of the rotor 10 are coupled to each other by performing welding on welding locations W on an outer circumferential surface 11e of the rotor core 11 in a state in which the magnets 14 are fixed to the magnet housing holes 13 of the rotor core 11 with the plastic 15.

As shown in FIG. 1, each welding location W extends in the axial direction from an end face 11c to an end face 11d opposite to the end face 11c. The welding locations W are arranged at equal intervals in the circumferential direction. In the present embodiment, the welding locations W are located at positions that correspond to, in the radial direction, the gaps between circumferentially adjacent ones of the magnet housing holes 13.

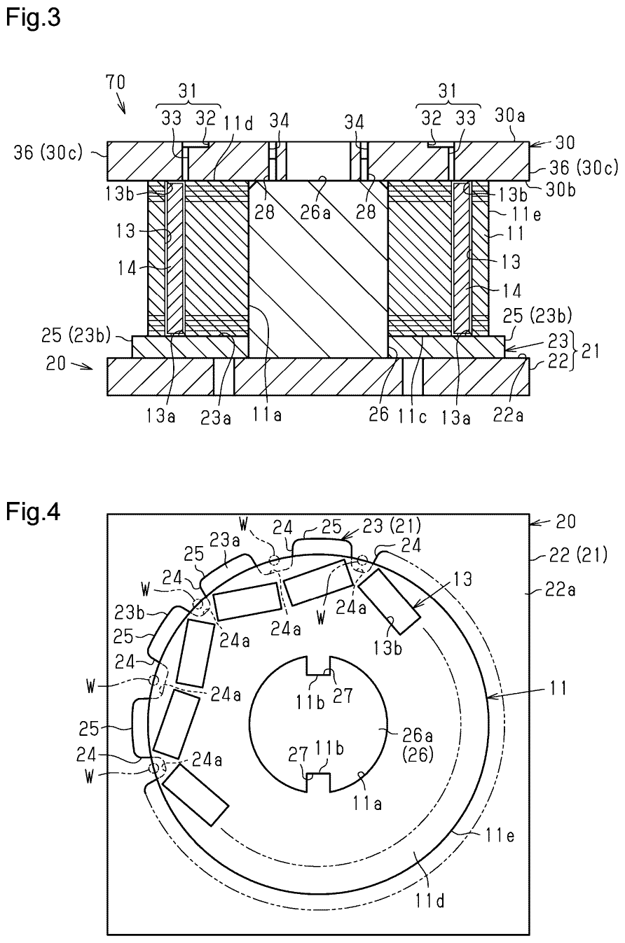

The manufacturing apparatus 70 for the rotor 10 will now be described with reference to FIGS. 3 to 6. In FIGS. 4 and 6, some of the components arranged successively are omitted and shown by long-dash double-short-dash lines. For illustrative purposes, the magnets 14 are omitted.

The manufacturing apparatus 70 includes a stacking jig 20, which supports the rotor core 11, and a cull plate 30, which is located on the opposite side in the axial direction of the rotor core 11 from the stacking jig 20. In the present embodiment, the stacking jig 20 corresponds to the first member according to the present disclosure, and the cull plate 30 corresponds to the second member according to the present disclosure.

In the following description, the side of the rotor core 11 toward the stacking jig 20 in the axial direction will be referred to as “below” or “lower side”, and the side of the rotor core 11 toward the cull plate 30 will be referred to as “above” or “upper side”.

### Stacking Jig 20

As shown in FIGS. 3 and 4, the stacking jig 20 includes a plate portion 21 and a post portion 26.

The plate portion 21 includes a lower plate 22 and an upper plate 23 arranged on an upper surface 22a of the lower plate 22.

The lower plate 22 is flat.

The upper plate 23 is substantially disc-shaped. An upper surface 23a of the upper plate 23 contacts the end face 11c of the rotor core 11 to close the first openings 13a of the magnet housing holes 13.

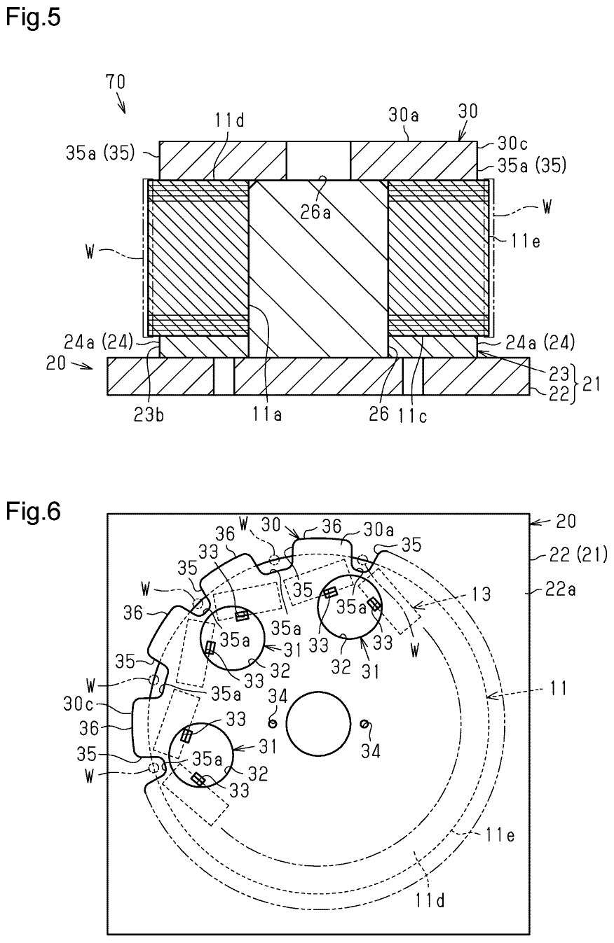

As shown in FIGS. 4 and 5, the upper plate 23 includes first escape portions 24, which are recesses formed in an outer circumferential surface 23b of the upper plate 23. A bottom surface 24a of each first escape portion 24 is located radially inward of the outer circumferential surface 11e of the rotor core 11.

The first escape portions 24 are located at parts that faces the respective welding locations W in the axial direction. The first escape portions 24 are located at positions that do not overlap with the magnet housing holes 13 in the axial direction.

The upper plate 23 includes portions 25 that are located radially outward of the outer circumferential surface 11e of the rotor core 11. The upper plate 23 is shaped such that the portions 25 and the first escape portions 24 are alternately arranged in the circumferential direction (refer to FIG. 4).

As shown in FIGS. 3 and 5, the post portion 26 is cylindrical and protrudes upward from a central portion of the lower plate 22. The post portion 26 extends through the upper plate 23. The post portion 26 is inserted into the center hole 11a of the rotor core 11.

The post portion 26 has two keyways 27 on the outer circumferential surface. The key portions 11b of the rotor core 11 are inserted into the keyways 27. When the key portions 11b of the rotor core 11 are inserted into the keyways 27 of the post portion 26, the phase of the rotor core 11 with respect to the lower plate 22, more specifically, the phase of each core piece block forming the rotor core 11 is determined.

Positioning pins 28, which protrude upward, are provided at the upper end 26a of the post portion 26. The positioning pins 28 are spaced apart from each other in the circumferential direction. The positioning pins 28 are omitted in FIG. 4.

### Cull Plate 30

As shown in FIGS. 3 and 5, the cull plate 30 is located on the end face 11d of the rotor core 11 to close the second openings 13b of the magnet housing holes 13.

As shown in FIGS. 3 and 6, the cull plate 30 includes supply portions 31, which fill the respective magnet housing holes 13 with the plastic 15. The supply portions 31 are provided at equal intervals in the circumferential direction. Each supply portion 31 is provided at a position that corresponds to a part between two of the magnet housing holes 13.

Each supply portion 31 includes a runner portion 32 and two connection holes 33, which connect the runner portion 32 to the corresponding magnet housing holes 13.

The runner portion 32 opens in an upper surface 30a of the cull plate 30. Each connection hole 33 opens in the bottom surface of the corresponding runner portion 32 and extends through the cull plate 30 in the axial direction. That is, each connection hole 33 also opens in a lower surface 30b of the cull plate 30.

The cull plate 30 includes positioning holes 34, into which the positioning pins 28 are inserted, in a central portion.

As shown in FIGS. 5 and 6, the cull plate 30 includes second escape portions 35, which are recesses formed in an outer circumferential surface 30c of the cull plate 30. A bottom surface 35a of each second escape portion 35 is located radially inward of the outer circumferential surface 11e of the rotor core 11.

The second escape portions 35 are located at parts that faces the respective welding locations W in the axial direction. The second escape portions 35 are located at positions that do not overlap with the magnet housing holes 13 in the axial direction.

The cull plate 30 includes portions 36 that are located radially outward of the outer circumferential surface 11e of the rotor core 11. The cull plate 30 is shaped such that the portions 36 and the second escape portions 35 are alternately arranged in the circumferential direction (refer to FIG. 6). In the present embodiment, the cull plate 30 has the same shape as the upper plate 23 in plan view.

### Method of Manufacturing Rotor 10

A method of manufacturing the rotor 10 will now be described with reference to FIGS. 3 and 7 to 9.

The method of manufacturing the rotor 10 includes a first transport step, a plastic filling step, a second transport step, and a welding step.

First, as shown in FIG. 3, the rotor core 11 is placed on the upper surface 23a of the upper plate 23 of the stacking jig 20. Next, the magnets 14 are inserted into and accommodated in the magnet housing holes 13 from the second openings 13b. Then, the cull plate 30 is arranged on the end face 11d of the rotor core 11. At this time, positioning pins 28 are inserted into the positioning holes 34 to determine the position of the post portion 26, that is, the position of the cull plate 30, with respect to the stacking jig 20.

The stacking jig 20, the rotor core 11, the magnets 14, and the cull plate 30 are transported to a space between a first die 40 and a second die 50, which is configured to approach and separate from the first die 40 (this completes the first transport step).

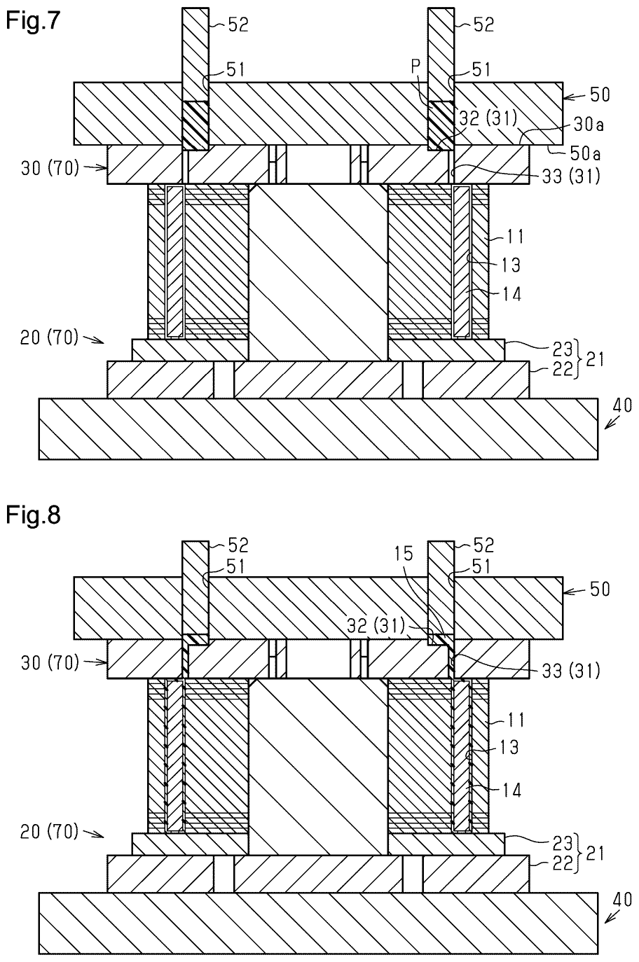

Next, as shown in FIG. 7, the second die 50 is brought closer to the first die 40, so that a lower surface 50a of the second die 50 contacts the upper surface 30a of the cull plate 30. The second die 50 includes supply passages 51 that supply the plastic 15 to the respective supply portions 31. Plastic pellets P made of thermosetting plastic are arranged in each supply passage 51. The thermoplastic pellets P are, for example, heated to a specified temperature by a heater (not shown) arranged inside the second die 50 and melted in the supply passages 51. The second die 50 includes plungers 52 configured to be inserted into and removed from the supply passages 51. Each plunger 52 applies pressure to the plastic 15, which has been melted in the supply passage 51, in order to fill the magnet housing hole 13 with the plastic 15. Accordingly, as shown in FIG. 8, the plastic 15 fills the magnet housing holes 13 via the supply portions 31. The plastic 15 filling the magnet housing holes 13 is hardened by being placed in a heating device (not shown) together with the manufacturing apparatus 70 (this completes the plastic filling step).

Next, the stacking jig 20, the rotor core 11, in which the magnets 14 are fixed to the magnet housing holes 13 by the plastic 15, and the cull plate 30 are removed from the space between the first die 40 and the second die 50 and transported to a welding line (this completes the second transport step).

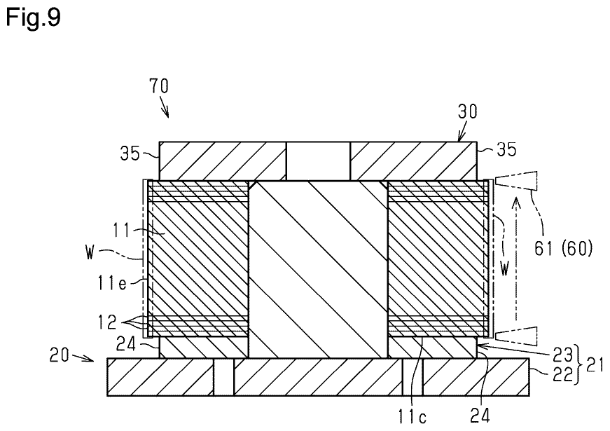

Then, as shown in FIG. 9, the welding line is provided with a welding machine 60, which includes welding torches 61 for welding the iron core pieces 12 of the rotor core 11 to each other. The welding method is, for example, laser beam welding.

The welding torches 61 are provided to be lifted and lowered in the axial direction of the rotor core 11. The welding torches 61 perform welding on the welding locations W while moving in the axial direction as indicated by the long-dash double-short-dash lines in FIG. 9. This welds the iron core pieces 12 to each other (this completes the welding step).

The rotor 10 is manufactured in the above-described manner.

The present embodiment has the following advantages.

(1) The manufacturing apparatus 70 includes the stacking jig 20 and the cull plate 30. The stacking jig 20 is configured to contact the end face 11c of the rotor core 11 and close the first openings 13a of the magnet housing holes 13, which open in the end face 11c. The cull plate 30 is configured to be arranged to close the second openings 13b of the magnet housing holes 13. The cull plate 30 includes the supply portions 31 configured to supply the plastic 15 to the second openings 13b.

With this configuration, the plastic 15 is supplied to the second openings 13b of the magnet housing holes 13 via the supply portions 31 of the cull plate 30. This fills the magnet housing holes 13 with the plastic 15.

(2) The escape portions 24 are each provided in a part of the upper plate 23 of the stacking jig 20 that is configured to face, in the axial direction, the corresponding welding location W, at which the iron core pieces 12 are to be welded to each other. The escape portions 24 are located inward of the outer circumferential surface 11e of the rotor core 11.

This configuration prevents welding of the rotor core 11 and the upper plate 23 when each welding torch 61 of the welding machine 60 performs welding on a part of the corresponding welding location W close to the end face 11c in the axial direction. In addition, even if the welding torch 61 interferes with the upper plate 23 when performing welding on that part, the corresponding first escape portion 24 receives the welding torch 61, thereby limiting the interference of the welding torch 61 with the upper plate 23.

Consequently, it is possible to perform welding on the welding locations W of the rotor core 11 without having to remove the upper plate 23, and hence the stacking jig 20. Therefore, the stacking jig 20 can be standardized for both the plastic filling step and the welding step.

In the above-described configuration, the step for removing the stacking jig 20 from the rotor core 11 between the plastic filling step and the welding step is omitted. Therefore, this configuration reduces the likelihood of damaging the rotor core 11 when removing the stacking jig 20 from the rotor core 11.

(3) Parts of the cull plate 30 that are configured to face the welding locations W in the axial direction are provided with the second escape portions 35, which are located radially inward of the outer circumferential surface 11e of the rotor core 11.

This configuration allows the cull plate 30 to operate in the same manner as depicted in the advantage (2). Thus, the stacking jig 20 and the cull plate 30 can be standardized for use in both the plastic filling process and the welding process.

In the above-described configuration, the step for removing the cull plate 30 from the rotor core 11 between the plastic filling step and the welding step is omitted. Therefore, this configuration reduces the likelihood of damaging the rotor core 11 when removing the cull plate 30 from the rotor core 11.

(4) The method of manufacturing the rotor 10 includes the first transport step, the plastic filling step, the second transport step, and the welding step.

This method achieves operational advantages similar to the advantages (1) to (3).

### Modifications

The above-described embodiment may be modified as follows. The above-described embodiment and the following modifications can be combined as long as the combined modifications remain technically consistent with each other.

The cull plate 30 does not necessarily need have the shape in which the portions 36, which are located radially outward of the outer circumferential surface 11e of the rotor core 11, and the second escape portions 35 are alternately arranged in the circumferential direction. The cull plate 30 may be configured such that parts of the outer circumferential surface 30c other than the second escape portions 35 are flush with the outer circumferential surface 11e of the rotor core 11. Alternatively, as long as the second openings 13b of the magnet housing holes 13 are closed, the outer circumferential surface 30c may be shaped to be located radially inward of the outer circumferential surface 11e of the rotor core 11 over the entire circumference.

The cull plate 30 does not necessarily need to have multiple second escape portions 35, but may have a circular shape in plan view. That is, the outer circumferential surface 30c of the cull plate 30 may be a second escape portion over the entire circumference.

The plastic 15 is not limited to the thermosetting plastic described in the above-described embodiment, but may be, for example, a thermoplastic such as a liquid crystal polymer (LCP). In this case, a runner plate having runners and gates that supply molten thermoplastic to the magnet housing holes 13 may be used in place of the cull plate 30. In this case also, second escape portions are provided in the runner plate.

The escape portions 35 may be omitted from the cull plate 30. In this case, the cull plate 30 is detached from the rotor core 11 in the welding state, and a welding jig is placed on the end face 11d of the rotor core 11.

The upper plate 23 does not necessarily need have the shape in which the portions 25, which are located radially outward of the outer circumferential surface 11e of the rotor core 11, and the first escape portions 24 are alternately arranged in the circumferential direction. The upper plate 23 may be configured such that parts of the outer circumferential surface 23b other than the first escape portions 24 are flush with the outer circumferential surface 11e of the rotor core 11. Alternatively, as long as the first openings 13a of the magnet housing holes 13 are closed, the outer circumferential surface 23b may be shaped to be located radially inward of the outer circumferential surface 11e of the rotor core 11 over the entire circumference.

The upper plate 23 does not necessarily need to have multiple first escape portions 24, but may have a circular shape in plan view. That is, the outer circumferential surface 23b of the upper plate 23 may be a first escape portion over the entire circumference.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A manufacturing apparatus for a rotor, the rotor including a cylindrical rotor core that is formed by stacking multiple iron core pieces and includes magnet housing holes for accommodating magnets, and a plastic that fills the magnet housing holes, the iron core pieces being welded to each other so as to be coupled together, the manufacturing apparatus comprising:
a first member that is configured to contact one end face of the rotor core and close first openings of the magnet housing holes that open in the one end face; and
a second member that is configured to close second openings of the magnet housing holes on a side opposite to the first openings, the second member including a supply portion configured to supply the plastic to the second openings, wherein
a direction in which an axis of the rotor core extends is defined as an axial direction,
an escape portion is provided in a portion of the first member that is configured to face, in the axial direction, a welding location at which the iron core pieces are to be welded to each other, the escape portion being located inward of an outer circumferential surface of the rotor core.

2. The manufacturing apparatus for a rotor according to claim 1, wherein
the escape portion is a first escape portion, and
a second escape portion is provided in a portion of the second member that is configured to face the welding location in the axial direction, the second escape portion being located inward of the outer circumferential surface of the rotor core.

3. A method of manufacturing a rotor using the manufacturing apparatus for a rotor according to claim 1, the method comprising:
transporting the first member, the rotor core, and the second member to a space between a first die and a second die, the second die being provided to approach and separate from the first die;
filling the magnet housing holes with the plastic by supplying the plastic from the second die to the second openings through the supplying portion;
transporting the first member and the rotor core from the space between the first die and the second die to a welding line that welds the iron core pieces to each other; and
performing welding on the welding location of the rotor core in the welding line in a state in which the rotor core is in contact with the first member.
